(19) United States
(12) Patent Application Publication
(10) Pub. No.: US 2010/0107044 A1
(43) Pub. Date: Apr. 29, 2010

(54) SYSTEM AND METHOD FOR DEFINING LAYOUT OF AN ELECTRONIC BUSINESS CARD

(75) Inventor: HUI-HSIANG LI, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/471,395

(22) Filed: May 24, 2009

(30) Foreign Application Priority Data
Oct. 20, 2008 (CN) 200810305012.X

(51) Int. Cl. G06F 17/30; G06F 3/048; G06F 12/00

(52) U.S. Cl. 715/201; 715/253; 711/103; 711/115; 711/E12.001; 707/E17.019

(57) ABSTRACT

A system and method for defining layout of an electronic business card reads a multimedia message to which the electronic business card is attached from a storage, analyzes the multimedia message to retrieve image information and audio information of the multimedia message, and parses the electronic business card to retrieve text information of the electronic business card. The system and method further sets associations between the text information in each paragraph of the electronic business card and the image information and the audio information of the multimedia message, sets display layout and display duration of the associated text information and image information, and displays the text information of the electronic business card accompanied by the image and audio information of the multimedia messages according to the associations, the display layout and display duration.

### BACKGROUND

1. Technical Field

Embodiments of the present disclosure are related to multimedia message service (MMS) systems and methods, and particularly to a system and method for defining layout of an electronic business card.

2. Description of Related Art

Nowadays, electronic business cards, such as vcards, are widely used for exchanging information between electronic devices, such as mobile phones. An electronic business card can be attached to and sent with emails or messages (such as MMS messages). Receivers can store the electronic business card and display the electronic business card to fetch company or individual information of a transmitter. However, at present, layout of the business cards are uniform (as shown in FIG. 1), which lacks flexibility and attraction.

### BRIEF DESCRIPTION OF THE DRAWINGS

FIG. 1 is a block diagram of one embodiment showing text information of an electronic business card.

FIG. 2 is a block diagram of one embodiment of a system for defining layout of the electronic business card.

FIG. 3 is a flowchart of one embodiment of a method for defining layout of an electronic business card.

FIG. 4-FIG. 8 are of one embodiment showing the defined layout of the electronic business card.

### DETAILED DESCRIPTION

All of the processes described may be embodied in, and fully automated via, functional code modules executed by one or more general purpose computers or processors. The code modules may be stored in any type of computer-readable medium or other storage device. Some or all of the methods may alternatively be embodied in specialized computer hardware or electronic apparatus.

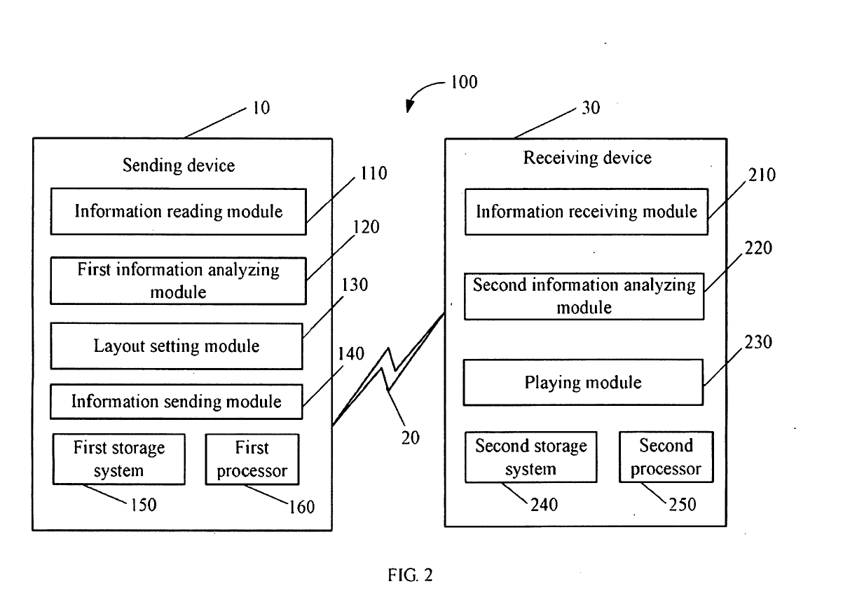

FIG. 2 is a block diagram of one embodiment of a system 100 for defining layout of an electronic business card (e-business card). In one embodiment, the system 100 includes a sending device 10 and at least one receiver 30 (only one shown in FIG. 2). The sending device 10 and the receiving device 20 communicate with each other via a network 20. Depending on the embodiment, the sending device 10 and the receiving device 20 may be mobile phones, person digital assistants, or computers. The network 20 may be a mobile phone network, such as a global system for mobile communication (GSM) network, a wireless local area network, or the Internet.

The sending device 10 includes an information reading module 110, a first information analyzing module 120, a layout setting module 130, and an information sending module 140. Programs, such as computerized codes of the modules 110-140 and other applications of the sending device 10 are stored in a first storage system 150 of the sending device 10. In one embodiment, the first storage system 150 may be an external storage card, e.g., a smart media card, a secure digital card, a compact flash card, or any other type of memory card. A first processor 160 executes the computerized codes of the modules 110-140 and the other applications, to provide functions of the sending device 10.

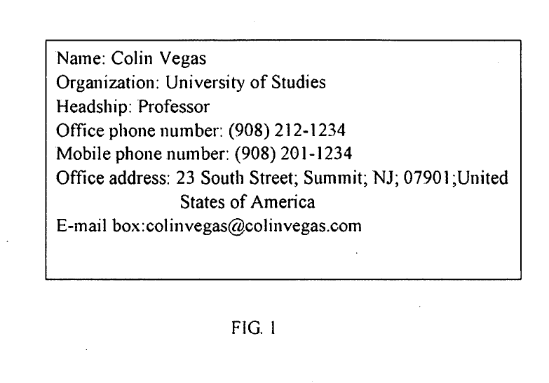

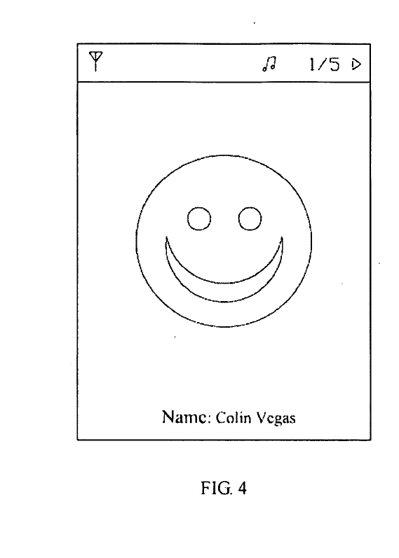

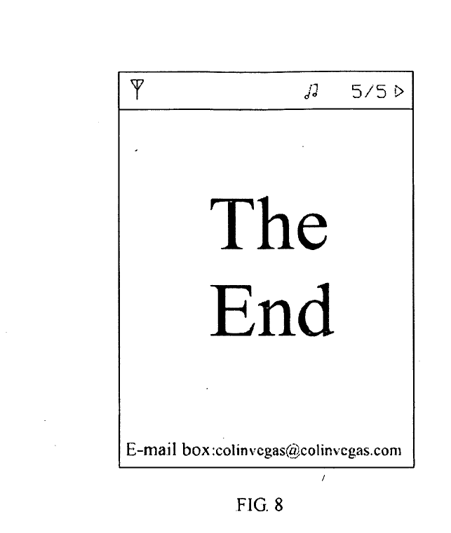

The information reading module 110 reads a multimedia message and an e-business card to be attached to the multimedia message that are selected by a user of the sending device 10 from the first storage system 150. For example, the multimedia message may include image information and audio information, such as a first image having a smiley face (as shown in FIG. 4) and a background audio “Hello, everyone!” and a second image having characters “THE END” in a predetermined font (as shown in FIG. 8) with a background audio “Welcome to communicate!” The e-business card includes text information formatted into a plurality of paragraphs (as shown in FIG. 1). The multimedia message may be sent via the network 20, for example.

The first information analyzing module 120 analyzes the multimedia message to retrieve the image information and audio information from the multimedia message, and parses the electronic business card to retrieve the text information in each paragraph of the e-business card.

The layout setting module 130 sets associations between the text information in each paragraph of the e-business card and the image information and audio information of the multimedia message, and further sets display layout and display duration of the associated text information and image information. For example, the layout setting module 130 may set the text information in each paragraph of the e-business card to associate with different images having different background audio in the multimedia message, or may set the text information in each paragraph of the e-business card to associate with one image having the same background audio in the multimedia message. The display layout includes layers of an image and associated text information of the image. It may be understood that, the image and the associated text information of the image may be in the same layer or in different layers. The display layout further includes positions of the image and the associated text information of the image in the layers. The display duration defines display time of the image and the associated text information of the image. Further details of the image layers will be explained below.

After the setting operation, the information sending module 140 sends the multimedia message and the e-business card to the receiving device 30.

The receiving device 30 includes an information receiving module 210, a second information analyzing module 220, and a playing module 230. Programs, such as computerized codes of the modules 210-230 and other applications of the receiving device 30 are stored in a second storage system 240 of the receiving device 30. In one embodiment, the second storage system 240 may be an external storage card, e.g., a smart media card, a secure digital card, a compact flash card, or any other type of memory card. A second processor 250 executes the computerized codes of modules 210-230 and the other applications, to provide functions of the receiving device 30.

The information receiving module 210 receives the multimedia message and the e-business card attached to the multimedia message from the sending device 10, and stores the multimedia message and the e-business card in the second storage system 240.

The second information analyzing module 220 analyzes the multimedia message and the e-business card, so as to retrieve the associations between the text information of the e-business card and the image information and audio information of the multimedia message, and further to retrieve the display layout and display duration of the associated text information and image information.

The playing module 230 displays the text information of the e-business card accompanied by the image and audio information of the multimedia messages on a screen (not shown) of the receiving device 30, according to the retrieved associations, the retrieved display layout and display duration of the associated text information and image information.

It may be understood that, in other embodiments, the modules 110-140 of the sending device 10 and the modules 210-230 of the receiving device 30 can be included in one electronic device, for example, in the sending device 10 or in the receiving device 30, so that the sending device 10 or the receiving device 30 defines layout of an electronic business card, and then displays the defined layout of the electronic business card on its own screen.

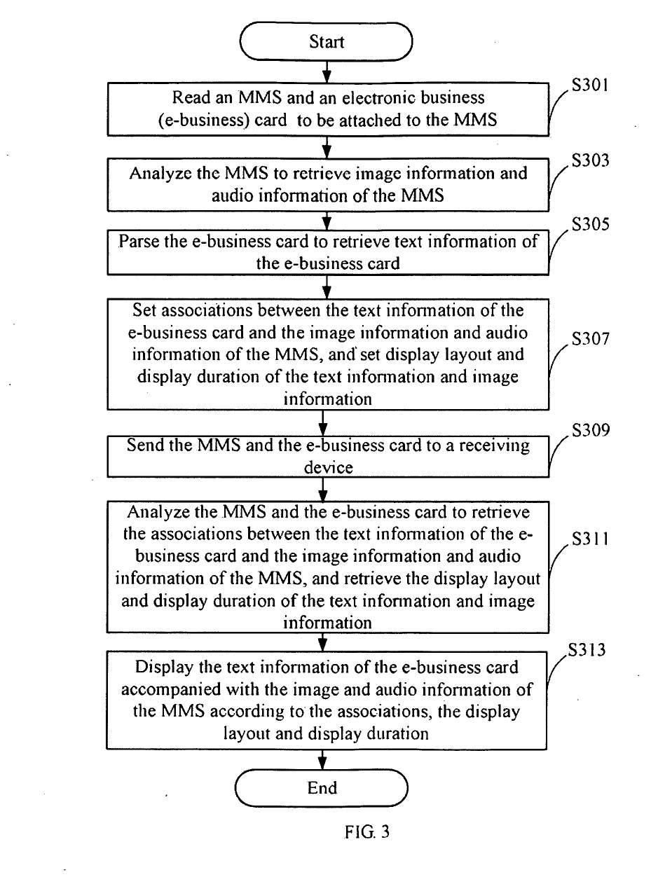

FIG. 3 is a flowchart of one embodiment of a method for defining layout of an e-business card. Depending on the embodiment, additional blocks may be added, others removed, and the ordering of the blocks may be changed.

In block S301, the information reading module 110 reads a multimedia message and reads an e-business card from the first storage system 150 to be attached to the multimedia message that are selected by a user of the transmitter 10 from the first storage system 150. In this embodiment, the multimedia message includes two images with respective background audio, such as a first image having a smiley face (as shown in FIG. 4) with a background audio “Hello, everyone!” and a second image having characters “THE END” in a predetermined font (as shown in FIG. 8) with a background audio “Welcome to communicate!” The e-business card includes text information formatted in a plurality of paragraphs (as shown in FIG. 1).

In block S303, the first information analyzing module 120 analyzes the multimedia message to retrieve the images and the background audio from the multimedia message.

In block S305, the first information analyzing module 120 parses the electronic business card attached to the received multimedia message to retrieve the text information in each paragraph of the e-business card.

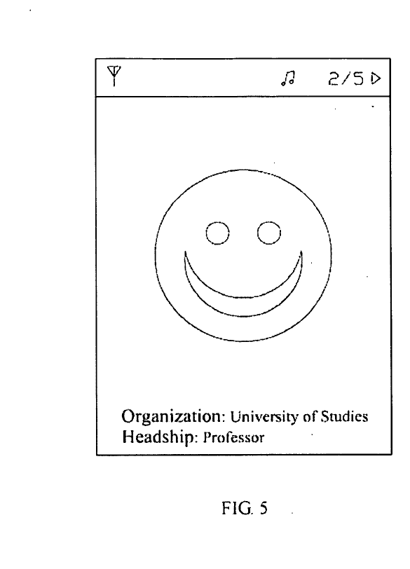

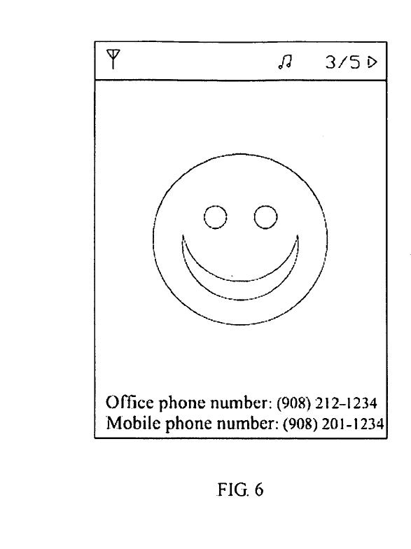

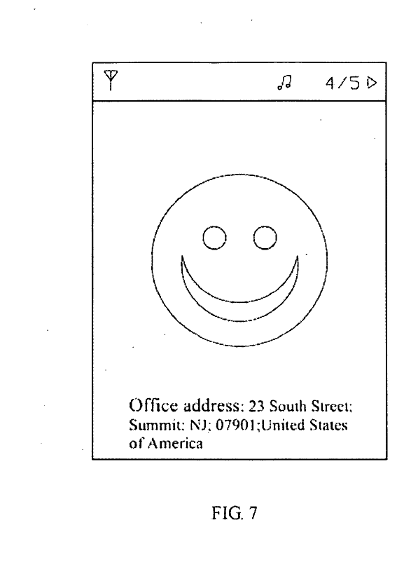

In block S307, the layout setting module 130 sets associations between the text information in each paragraph of the e-business card and the image information and audio information of the multimedia message, and further sets display layout and duration of the associated text information and image information. For example, in this embodiment, the layout setting module 130 sets the text information “Name: Colin Vegas” in the first paragraph of the e-business card to associate with the first image having the smiley face (as shown in FIG. 4) and the background audio “Hello, everyone!” Furthermore, the layout setting module 130 sets the text information “Organization: University of Studies” and “Headship: Professor” in the second and third paragraphs of the e-business card together to associate with the first image having the smiley face without background audio (as shown in FIG. 5), sets the text information “Office phone number: (908) 212-1234” and “Mobile phone number: (908) 201-1234” in the forth and fifth paragraphs of the e-business card together to also associate with the first image having the smiley face without background audio (as shown in FIG. 6), sets the text information “Office address: 23 South Street; Summit; N.J.; 07901 ; United States of America” in the six paragraph of the e-business card together to also associate with the first image having the smiley face without background audio (as shown in FIG. 7), and sets the text information “E-mail box:colinvegas@colinvegas.com” to associate with the second image having the characters “THE END” in the predetermined font (as shown in FIG. 8) and the background audio “Welcome to communicate!”

In this embodiment, the layout setting module 130 sets each image to be in a background layer and the associated text information of each image to be in a foreground layer, sets the associated text information of the image to be shown at the bottom of the image, and sets display duration of each image and associated text information of the images as 5 seconds.

In block S309, the information sending module 140 sends the multimedia message attached with the e-business card to the receiving device 30, the information receiving module 210 of the receiving device 30 stores the multimedia message and the e-business card attached to the multimedia message in the second storage system 240.

In block S311, the second information analyzing module 220 analyzes the multimedia message and the e-business card, so as to retrieve the associations between the text information of the e-business card and the image information and audio information of the multimedia message, and further to retrieve the display layout and display duration of the associated text information and image information by.

In block S313, the playing module 230 displays the text information of the e-business card accompanied by the image and audio information of the multimedia messages on the screen of the receiving device 30, according to the retrieved associations, the retrieved display layout and display duration of the associated text information and image information. Thus, referring to FIG. 4 to FIG. 8, text information of the e-business card may be shown in slides with background images and audio.

The above embodiments combine rich image information and audio information in multimedia messages to display text information of e-business cards, so that layouts of the e-business cards can be defined flexibly according to user preference to be more appealing and eye catching.

It should be emphasized that the above-described inventive embodiments are merely possible examples of implementations, and set forth for a clear understanding of the principles of the present disclosure. Many variations and modifications may be made to the above-described inventive embodiments without departing substantially from the spirit and principles of the present disclosure. All such modifications and variations are intended to be included herein within the scope of this disclosure and the above-described inventive embodiments, and the present disclosure is protected by the following claims.

What is claimed is:

1. An electronic business card layout system, the system comprising:
a storage system;
at least one processor; and
one or more programs stored in the storage system and being executable by the at least one processor, the one or more programs comprising:
an information reading module to read a multimedia message and an electronic business card to be attached to the multimedia message from the storage system;
a first information analyzing module to analyze the multimedia message to retrieve image information and audio information from the multimedia message, and parse the electronic business card to retrieve text information of the electronic business card;
a layout setting module to set associations between the text information of the electronic business card and the image information and audio information of the multimedia message, and set display layout and display duration of the associated text information and image information; and
an information sending module to send the multimedia message attached with the electronic business card to an electronic device after the setting operation.

2. The system as claimed in claim 1, further comprising:
an information receiving module to receive the multimedia message attached with the electronic business card;
a second information analyzing module to analyze the multimedia message and the electronic business card, so as to retrieve the associations between the text information of the electronic business card and the image information and audio information of the multimedia message, and to retrieve the display layout and display duration of the associated text information and image information; and
a playing module to display the text information of the electronic business card accompanied by the image and audio information of the multimedia messages on a screen of the electronic device, according to the retrieved associations, the retrieved display layout and display duration of the associated text information and image information.

3. The system as claimed in claim 1, wherein the storage system is selected from the group consisting of a smart media card, a secure digital card, and a compact flash card.

4. A method for defining layout of an electronic business card in a first electronic device, the method comprising:
reading a multimedia message and the electronic business card to be attached to the multimedia message from a first storage system by a processor of the first electronic device;
analyzing the multimedia message by the processor to retrieve image information and audio information from the multimedia message, and parsing the electronic business card by the processor to retrieve text information of the electronic business card; and
setting associations between the text information of the electronic business card and the image information and audio information of the multimedia message, and setting display layout and display duration of the associated text information and image information by the processor.

5. The method as claimed in claim 4, further comprising:
sending the multimedia message and the electronic business card to a second electronic device by the processor after the setting operation and storing the multimedia message and the e-business card in a second storage system;
analyzing the multimedia message and the electronic business card, so as to retrieve the associations between the text information of the electronic business card and the image information and audio information of the multimedia message, and to retrieve the display layout and display duration of the associated text information and image information; and
displaying the text information of the electronic business card accompanied by the image and audio information of the multimedia messages on a screen of the second electronic device, according to the retrieved associations, the retrieved display layout and display duration of the associated text information and image information.

6. The method as claimed in claim 4, wherein the first and second storage systems are selected from the group consisting of a smart media card, a secure digital card, and a compact flash card.

7. The method as claimed in claim 4, wherein the first and second electronic devices are selected from the group consisting of a mobile phone, a personal digital assistant, and a computer.

8. A storage medium storing a set of instructions, the set of instructions capable of being executed by a processor to perform a method for defining layout of an electronic business card, the method comprising:
reading a multimedia message and the electronic business card to be attached to the multimedia message from the storage medium;
analyzing the multimedia message to retrieve image information and audio information from the multimedia message, and parsing the electronic business card to retrieve text information of the electronic business card; and
setting associations between the text information of the electronic business card and the image information and audio information of the multimedia message, and setting display layout and display duration of the associated text information and image information; and
sending the multimedia message attached with the electronic business card to an electronic device after the setting operation.

9. The storage medium as claimed in claim 8, wherein the method further comprising:
receiving the multimedia message attached with the electronic business card;
analyzing the multimedia message and the electronic business card to retrieve the associations between the text information of the electronic business card and the image information and audio information of the multimedia message, and to retrieve the display layout and display duration of the associated text information and image information; and
displaying the text information of the electronic business card accompanied by the image and audio information of the multimedia messages on a screen of the electronic device, according to the retrieved associations, the retrieved display layout and display duration of the associated text information and image information.

10. The storage medium as claimed in claim 8, wherein the storage system is selected from the group consisting of a smart media card, a secure digital card, and a compact flash card.
